(19) United States
(12) Patent Application Publication
(10) Pub. No.: US 2023/0270306 A1
(43) Pub. Date: Aug. 31, 2023

(54) SUCTION DEVICE AND METHOD FOR DETERMINING THE FILLING LEVEL OF A FILTER DEVICE OF A SUCTION DEVICE

(71) Applicant: Vorwerk & Co. Interholding GmbH, Wuppertal (DE)

(72) Inventor: Pablo Mosquera Michaelsen, Mülheim (Ruhr) (DE)

(21) Appl. No.: 18/104,813

(22) Filed: Feb. 2, 2023

(30) Foreign Application Priority Data
Feb. 14, 2022 (EP) 22156600.3

(51) Int. Cl. A47L 9/28; A47L 9/12; A47L 9/24

(52) U.S. Cl. CPC A47L 9/2821; A47L 9/12; A47L 9/242

(57) ABSTRACT

A suction device with at least one fan for generating a suction air stream in a suction channel, at least one filter device for receiving suction material, at least one pressure measuring system and at least one control device, wherein the suction device is configured for coupling to a plurality of attachments on the suction channel, as well as a method for determining the filling level for a filter device of the suction device. The suction device and the method for determining the filling level ensures the most precise display possible of the filling level and also is simultaneously realizable in a cost-effective manner, in that the control device is configured and arranged for determining the filling level using at least one pressure measurement value and characteristic data, as well as for selecting the characteristic data used for the determination depending on the attachment connected to the suction device.

### CROSS REFERENCE TO RELATED APPLICATIONS

This application claims the benefit of priority under 35 U.S.C. § 119 to European Patent Application No.: 22156600.3, filed Feb. 14, 2022, the contents of which is incorporated herein by reference in its entirety.

### FIELD

The invention relates to a suction device with at least one fan for generating a suction air stream in a suction channel. The suction device also has at least one filter device for receiving suction material, at least one pressure measuring system, and at least one control device. The invention also relates to a method for determining the filling level of a filter device of a suction device. The suction device features at least one suction channel and is designed to be coupled to a plurality of various attachments on the suction channel.

### BACKGROUND

The statements in this section merely provide background information related to the present disclosure and several definitions for terms used in the present disclosure and may not constitute prior art.

Several embodiments of suction devices and methods for their operation are known as conventional technology. Vacuum cleaners, hand-held vacuum cleaners, vacuum robots, and vacuum and mop robots are usually designated as suction devices. In order to make it possible for the user to empty or exchange the filter device in a timely manner, it is known to determine the filling level of a filter device, for example the filling level of a filter bag, using a differential pressure measurement of the pressure in the flow direction upstream and downstream of the filter device. However, the differential pressure measurement results in significant additional costs for hoses, sealing elements, pressure sensors, as well as their assembly.

It is therefore an objective of the present disclosure to disclose a suction device as well as a method for determining the filling level, which ensures the most precise display of the filling level of the filter device but can simultaneously be cost-effectively realized.

### SUMMARY

The aforementioned objective of the present disclosure is attained with a generic suction device having at least one fan for generating a suction air stream in a suction channel, at least one filter device for receiving suction material, at least one pressure measuring system, and at least one control device, wherein the suction device is designed for coupling to a plurality of different attachments on the suction channel. The control device is configured and arranged for determining the filling level of the filter device using at least one pressure measurement value and from characteristic data. The characteristic data necessary for this determination must be selected in advance, so that the control unit is further arranged and configured for selecting the characteristic data used for the determination depending on the attachment connected with the suction device. The control device preferably features means for determining the filling level as described and performing the selection of the characteristic data.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 shows a partial sectional side view of an embodiment of a suction device according to the teachings of the present disclosure,

FIG. 2 shows a partial sectional perspective view of an embodiment of an attachment according to the teachings of the present disclosure, and

FIG. 3 shows an exemplary embodiment of a schematic sequence of a method according to the present disclosure.

The drawings are provided herewith for purely illustrative purposes and are not intended to limit the scope of the present invention.

### DETAILED DESCRIPTION

The following description is merely exemplary in nature and is in no way intended to limit the present disclosure or its application or uses. It should be understood that throughout the description, corresponding reference numerals indicate like or corresponding parts and features.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

In general, the suction device is a cleaning device in which a cleaning function is at least partially performed using a suction air stream, for example, a vacuum cleaner, and hand-held vacuum cleaner, a vacuum robot, or a vacuum and mop robot. Under attachment is understood as being any component which can be coupled to the suction device and through which the suction air at least partially flows. The suction channel is configured, for example, at least in part within the attachment. The attachment or attachments are preferably floor nozzles, brush units, upholstery nozzles, dust catcher nozzles, crevice nozzles, or other accessory nozzles and similar—active and passive—components.

The suction device is advantageously provided with a housing. The suction device features at least one fan for generating a suction air stream in the at least one suction channel. At least one filter device is connected to the suction channel, which is designed to receive suction material. At least a portion of the suction air flows through the filter device when the suction device is in operation so that the filter device can separate suction material from a suction air stream. The filter unit features, for example, a filter bag made of a filter fleece, a washable multilevel filter, or a filter cyclone. The filter unit features in any case a separation device, which is ideal for cleaning suction material out of the suction air stream.

The suction device furthermore features at least one pressure measuring system which is designed for measuring the pressure at least at one location of the suction channel, and in particular generating a measurement value from it, which is to be transmitted to a control device. The pressure measuring system advantageously features at least one pressure sensor, especially a pressure sensor with strain gauges, a variable capacitive pressure sensor, a piezoelectric pressure sensor, or an optical pressure sensor. The suction device preferably features exactly one pressure measuring system with exactly one pressure sensor.

The control device of the suction device comprises, for example, at least one data processing device, having at least one processor and at least one memory means. It is preferably provided that the control device furthermore features at least one data interface. The data interface is configured, for example, as a data interface according to a wireless communication standard, in particular WLAN, ZigBee, 5G, or Bluetooth.

The suction device is configured for coupling respectively to one attachment of a plurality of various attachments to the suction channel. The respectively one attachment can be disposed at one end of a suction channel that faces away from the suction device, so that the cleaning work can be conducted using the attachment. Each attachment can be connected to the suction device in a positive-locking or friction-locking manner.

In order to be able to determine the filling level of the filter device, the control device features a means for determining the filling level using at least one pressure measurement value from the pressure measuring system and from characteristic data. The selection of the characteristic data used for the determination takes place depending on an attachment which is connected to the suction device. The characteristic data preferably comprises empirical data, in particular data determined in the laboratory, for example, concerning the pressure at least at one position, preferably at a plurality of positions within the suction channel, with varying combinations of performance statuses of the fan, the filling level of the filter unit, and various attachments. The characteristic data are available in a memory means of the suction device. The characteristic data represents, for example, at least one overpressure characteristic which discloses the overpressure at a particular position in the suction channel as compared to the volumetric flow rate.

Which characteristic data are selected from among a multitude of characteristic data to determine the filling level using the pressure measurement value depends on which attachment is coupled to the suction device. Different attachments throttle the suction air stream in the suction channel in different ways, which has an effect upon the determination of the filling level. In order to determine the filling level of the filter device using only one pressure measurement value and the characteristic data available in the memory means, it is necessary to know the type of attachment. Different characteristic data will be drawn upon to determine the filling level of the filter device for each different attachment.

For example, the determination of pressure measurement values, selection, and determination of the filling level occur continuously, at specific time intervals, for specific time periods, and/or based on events.

According to one aspect of the present disclosure, it is provided, for example, that the determined filling level can be displayed to a user in the form of a fill status on a display device of the suction device. It is furthermore provided that the determined filling level is made available for display on a mobile terminal device on a data interface.

The suction device, preferably the control device, is advantageously configured and arranged for recognizing the presence of an attachment. If no attachment is connected to the suction device, then the control device is configured for determining the filling level of the filter device using the at least one pressure measurement value and from a portion of the characteristic data which is available for the case of the absence of an attachment.

Thus the control device consequently features at least one attachment interface, with which the detection of the presence of an attachment is made possible. Identification data with regard to the attachment can preferably be additionally received, transmitted, and in particular processed by the control device if an attachment is present. An attachment detection can advantageously be performed with the control device.

One aspect of the present disclosure that differs from conventional technology is that different, especially empirically determined characteristic data or another portion of the characteristic data is used to determine the filling level of each attachment. The different throttling properties of each attachment can thus be taken into account in the determination of the filling level. The present disclosure has the advantage in comparison to conventional technology in that the fill status of the filter unit can be disclosed with great precision, wherein the effort for realization is simultaneously low.

According to a first embodiment of the suction device, it has been advantageously discovered that, when it is provided, the at least one pressure measurement value represents an overpressure measurement value. The pressure measurement value advantageously represents an overpressure measurement value which has been recorded in the airflow channel at a location in the flow direction behind the fan. The pressure measuring system is advantageously arranged behind the fan in the flow direction, whereby in particular an easy access to the pressure measuring system with simultaneously dependable measurement values is ensured.

In order to determine the filling level, it is provided according to another embodiment that the control device is designed and configured such that at least one comparison of the at least one pressure measurement value with at least one portion of the characteristic data takes place. A comparison occurs preferably with at least the portion of the characteristic data that is selected depending on the attachment which is connected to the suction device for the determination by the control unit. A filling level is assigned to a pressure measurement value by comparing the pressure measurement value to at least a portion of the characteristic data.

It has proven to be particularly advantageous according to a further embodiment of the suction device if it is provided that at least a portion of the characteristic data represents a plurality of overpressure threshold values, wherein each overpressure threshold value is assigned to at least one, in particular empirically determined, filling level of the filter device. The current pressure measurement value, in particular the overpressure measurement value, is compared to each of the plurality of overpressure threshold values within the scope of the determination of the filling level. If there is correspondence, or if the currently measured pressure measurement value falls within the range defined by the overpressure threshold values, then the current pressure measurement value is assigned to this overpressure threshold value and the corresponding filling level of the filter device is selected as the current filling level of the filter device.

In order to make possible dependency of the characteristic data from the attachment, it is provided according to a further embodiment that a different data set, that is, a plurality of overpressure threshold values for different throttle conditions in the suction channel is kept available for each attachment out of a multitude of attachments. At least one individual set of overpressure threshold values is especially available for every combination of power settings of the fan and every attachment out of a plurality of attachments.

The determination of the filling level of the filter device, along with the air flow properties in the suction channel, is influenced by the power setting of the fan which is selected by the user. According to a further embodiment of the suction device, it is therefore provided that the control device is arranged and configured in such a way that a selection of the characteristic data used for the determination is also dependent on the power setting of the fan selected by a user. The suction device is provided, for example, with five power settings. In a memory means are consequently stored characteristic data for each of the five power settings, which represent, for example, which pressure measurement value, in particular which overpressure measurement value, corresponds to which filling level of the filter unit.

According to a further embodiment of the suction device, the identification data pertaining to the attachment are processed, for example, preserved or generated, by reading at least one identification means of the attachment in order to identify the attachment that is coupled to the suction device. It is provided that identification data are transferred and/or generated at an attachment interface.

It is provided that the attachment interface features at least one physical contact, for example, a plug connector, in order to electrically connect the attachment to the control unit. For example, the physical contact enables the exchange of data via electrical lines, preferably at any rate, however, the identification of the attachment by the control unit, that is, the processing of identification data.

It is also provided that the attachment has at least one RFID chip, which is read by a correspondingly designed attachment interface of the suction device, in order to thereby generate identification data which can be used by the control unit for the determination of the filling level. The attachment interface is configured, for example, as a Bluetooth interface or another near-field communication interface.

It is furthermore provided that the attachment identification data is especially actively made available or transmitted to the control unit at an attachment interface.

It is advantageously alternatively or additionally provided that the identification data concerning the attachment is processed and/or made available and/or generated at a data interface of the suction device. For example, the user inputs information concerning the identification of the attachment in a mobile terminal device, for example, a smart phone, and the latter then provides corresponding identification data for the suction device at the data interface. It is additionally provided that the user scans, for example, a data code on the attachment with a mobile terminal device, for example a smart phone, whereby the smart phone generates identification data and transmits these via a data interface, for example WiFi, Bluetooth, or the like, to the suction device.

It is furthermore alternatively or additionally preferably provided that the control unit of the suction device can retrieve identification data of the attachment via a data interface in a network, or that these data are provided by the network, for example, via the internet, for example, from a server.

It has proven to be particularly advantageous in this context in a further embodiment, if provided, that at least a portion of the characteristic data, preferably all necessary characteristic data, are available in a memory means, in particular a memory means of the control device. Alternatively or additionally to this, it is provided that at least a portion of the characteristic data can be accessed or transmitted via a data interface. For example, the control device of the suction device can access a network, for example, the internet, via the data interface and thus in particular access new characteristic data from a server or a mobile terminal device belonging to the user.

It is furthermore provided that updated characteristic data or characteristic data for new attachments is actively transmitted via the data interface to the control device of the suction device or that, using its control device, the suction device can access this characteristic data via a network from a server or from a mobile terminal device. In this way, new characteristic data, for example, for newly acquired attachments, can be transmitted to the suction device.

According to a further embodiment, especially to tax as little as possible the working memory of the control device, it is provided that the control device is configured and arranged in such a way that at least a portion of the characteristic data, in particular the characteristic data which is relevant for the power setting currently selected by the user and the currently coupled attachment, is loaded by the control device from the memory means and provided for the determination every time the suction device is turned on and/or every time the attachment is changed and/or every time the power setting is changed. The loaded characteristic data is particularly provided for a comparison with the currently measured pressure measurement value.

The present disclosure further relates to a method with method steps, which were described for the preceding exemplary embodiments of the suction device.

The objective of the present disclosure specified initially is additionally attained by means of a method for determining the filling level of the filter device of a suction device with at least one suction channel. The suction device is configured for coupling to a plurality of different attachments on the suction channel. The method features at least the following method steps:
Processing identification data of an attachment coupled to the suction device;
Determining at least one pressure measurement value within the suction channel; and
Determining at least one filling level of the filter device using the processed identification data of the attachment, the pressure measurement value, as well as the characteristic data.

The method comprises the processing of identification data of an attachment coupled to the suction device. This identification data can also represent the information that no attachment is coupled to the suction device. The processing of identification data comprises, for example, receiving, supplementing, generating, and/or transmitting identification data.

A determination of at least one pressure measurement value within the suction channel takes place before this point, at the same time, or after this point.

A filling level of the filter device is subsequently determined using the processed identification data of the attachment, the at least one pressure measurement value, as well as characteristic data, in particular in such a fashion as was previously described for the exemplary embodiments of the suction device. The determination of the pressure measurement value within the suction channel preferably takes place with a pressure measuring system of the suction device.

According to one embodiment of the method, it is provided that the determination of the filling level comprises the selection of characteristic data. The selection of the characteristic data is preferably performed using the identification data. The selection of the characteristic data which is used for determining the filling level thus takes place depending on the attachment which is coupled to the suction device. As a result, the characteristic data which are used for the determination are those which are relevant for the throttle condition in the suction channel generated by the currently coupled attachment.

A further embodiment of the method provides that the selection of the characteristic data is carried out depending on a power setting of the fan which is chosen by the user. The power setting of the fan also influences the pressure ratios within the suction channel. In order to be able to determine the filling level of the filter unit on the basis of a current pressure measurement value and the characteristic data in a memory unit, it is consequently necessary to take into consideration the power setting chosen by the user.

According to a further embodiment of the method, it has proven to be particularly advantageous if it is provided that the determination of the filling level of the filter unit comprises a comparison of the pressure measurement value, in particular the currently determined pressure measurement value, to at least a portion of the selected characteristic data, in particular as was previously described for the exemplary embodiments of the suction device.

According to another embodiment of the method, it is provided that at least a portion of the characteristic data represents a plurality of overpressure threshold values, wherein each overpressure threshold value is assigned to at least one filling level of the filter device. By comparing the currently obtained pressure measurement value to the stored overpressure threshold values, the corresponding filling level of the filter device can be determined and selected as the current filling level of the filter device.

It is preferably provided that a different data set of overpressure threshold values is available in the characteristic data for each attachment out of a plurality of attachments. It is additionally provided that particularly an individual set of overpressure threshold values is available for every combination of power settings of the fan and every attachment out of a plurality of attachments. In this way, an easy determination of the filling level of the filter device is possible by means of a comparison of the current pressure measurement value with the overpressure threshold values selected for the determination.

A further embodiment of the method provides that the processing of identification data comprises the generation of identification data by the control device and/or the reception and/or transmission of identification data via an attachment interface and/or the reception and/or transmission of identification data concerning the coupled attachment via a data interface, especially as previously described for the exemplary embodiments of the suction device.

It is alternatively or additionally provided that identification data are received or transmitted via an attachment interface. The attachment interface comprises, for example, a data interface for the attachment, via which the attachment can transmit data or data can be received by the control device. The attachment interface is configured, for example, as a physical contact, for example, a plug connector.

As an additional alternative or addition, it is provided that the reception and/or transmission of identification data relating to the currently coupled attachment via a data interface is comprised. For example, the user transmits identification data concerning the currently coupled attachment to the control device of the suction device via an entry on his/her smart phone.

According to yet another embodiment of the method, it has proven to be particularly advantageous if it is provided that the overpressure threshold values which correspond to the current combination of power setting and attachment are read by the control device from the memory means every time the suction device is turned on and/or every time the attachment is changed and/or every time the power setting of the fan is changed for the purpose of assigning a fill status and are made available for determining the filling level. The workload of a working memory of the control device can be reduced in this way.

The present disclosure furthermore relates to a suction device, in particular with a control device, which is configured and arranged for performing a method according to the previously described exemplary embodiments.

Additional advantageous embodiments of the invention arise from the following description of the figures. In the various figures of the illustration, the same components are always identified with the same reference numerals.

It is claimed with reference to the following description that the invention is not restricted to the exemplary embodiments and that it is therefore not limited to all or several features of the described feature combinations, but rather that each individual partial feature of the/each exemplary embodiment is also of importance for the object of the invention separately from all other partial features described in connection therewith, and also in combination with any features of another exemplary embodiment.

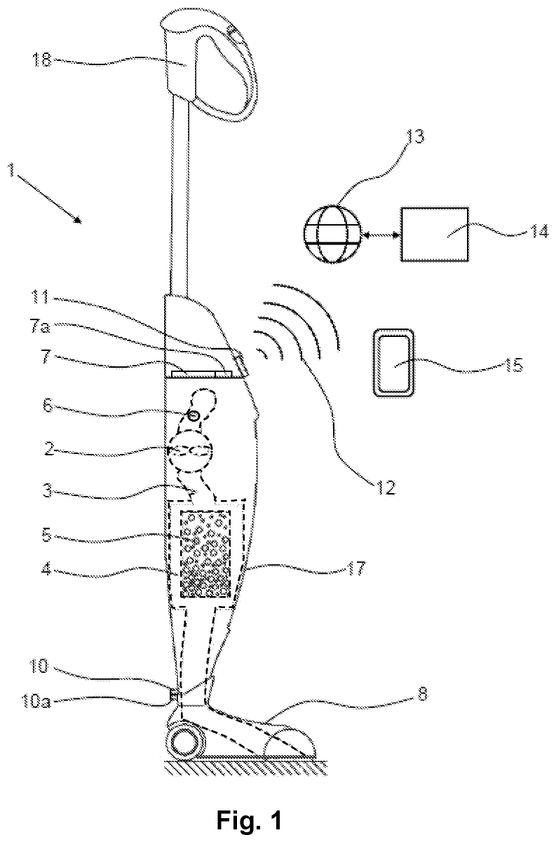

FIG. 1 shows a perspective view of an exemplary embodiment of a suction device 1, at least partial sectional side view. The suction device 1 features at least one fan 2 for generating the suction air stream in a suction channel 3. The suction device 1 further features a filter device 4 for receiving suction material 5. At least one pressure measuring system 6 is additionally located within the suction channel 3. The suction device 1 features a housing 17, within which the essential components of the suction device 1 are arranged. A hand grip 18 is arranged on the housing 17, with which the vacuum cleaner can be pushed and operated by a user.

Within the housing 17, the suction device 1 features a control device 7, which in this exemplary embodiment comprises a data processing device with a processor and a memory means 7a. The suction device 1 is configured for coupling to a plurality of different attachments 8 to be connected to the suction channel 3 on the suction device 1.

The control device 7 is configured and arranged for determining a filling level of the filter device 4 using at least one pressure measurement value and characteristic data. The control device 7 is furthermore configured and arranged in advance for the selection of the characteristic data used for the determination, depending on an attachment 8 which is connected to the suction device 1. The characteristic data is preferably stored or made available in a memory means 7a of the control device 7. According to one aspect of the present disclosure, the determination of the filling level of the filter device 4 thus takes place for each attachment 8 with different characteristic data or rather with a different portion of the characteristic data. It is thereby possible to determine the filling level of the filter device 4 with only one pressure measurement value.

According to FIG. 1, the pressure measuring system 6 is located behind the fan in the air flow direction. The identification data related to the attachment 8 is received or generated, for example, at the attachment interface 10. The attachment interface 10 is configured here as a plug connector, which interacts via electrical contact with a corresponding counter-interface 10a, here a plug counter-connector of the attachment 8.

As an alternative, it is provided that identification data concerning the attachment 8 coupled to the suction device 1 can also be processed, for example, received or generated, via a data interface 11.

The data interface 11 is configured and arranged for exchanging data or retrieving identification data and/or characteristic data from a server 14 via a network 12, which is configured, for example, as a near-field wireless network, such as a WLAN network, over the internet 13, or with a server 14 connected to the internet 13.

The data interface 11 is furthermore configured and arranged for exchanging data with a mobile terminal device 15, for example, the smart phone of a user, via a near-field wireless network or via a network 12. The user can, for example, enter identification data about an attachment 8 via the mobile terminal device 15, or the mobile terminal device 15 makes available characteristic data for a new attachment 8 at the data interface 11.

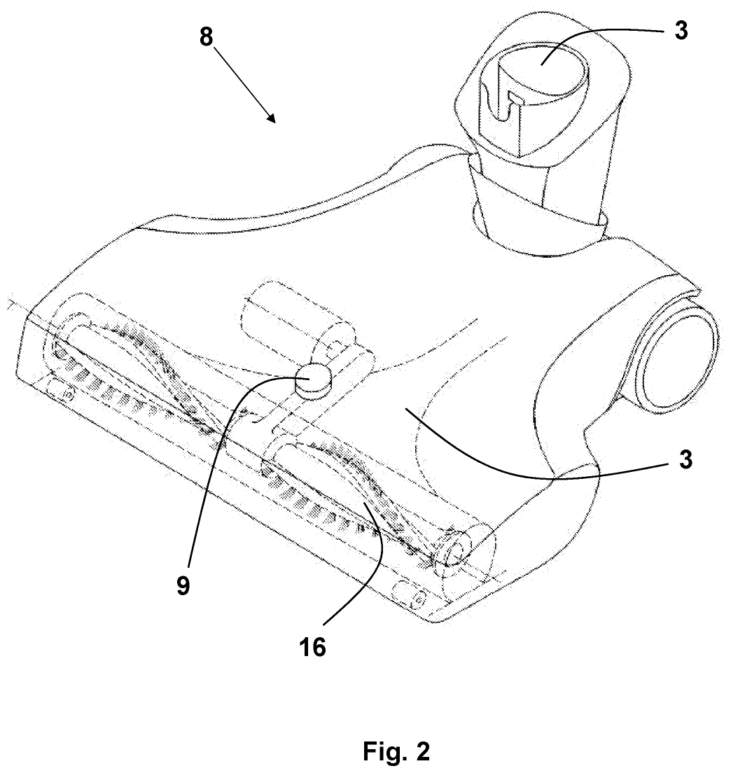

FIG. 2 shows an exemplary embodiment of an attachment 8 for a suction device 1, for example, according to FIG. 1. The attachment 8 according to FIG. 2 features a rotating floor brush 16, which is designed to loosen and conduct dirt to the suction channel 3. The attachment 8 has an identification means 9, here in the form of an RFID chip. The identification means 9 can be read by a correspondingly designed attachment interface 10 in order to receive identification data.

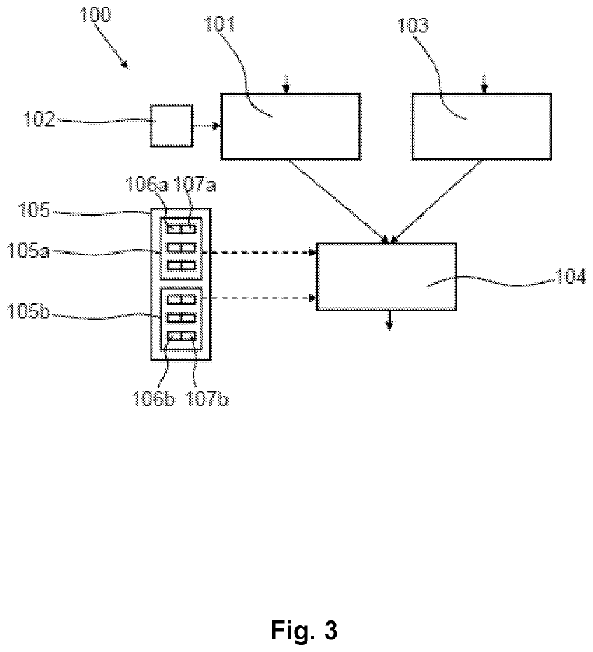

FIG. 3 shows an exemplary embodiment of a schematic sequence of a method 100 for determining a filling level of a filter device 4 of a suction device 1 with at least one suction channel 3. The suction device 1 is configured for coupling to a plurality of different attachments 8 on the suction channel 3. The method 100 comprises the step of processing 101 identification data 102 of an attachment 8 which is coupled to the suction device 1. The processing 101 can include the reception, transmission, or generation of identification data 102. The determination 103 of at least one pressure measurement value also takes place within the suction channel 3. The determination 104 of at least one filling level of the filter device 4 subsequently takes place using the processed identification data 102 of the attachment 8 as well as the pressure measurement value and the characteristic data 105.

The characteristic data 105 preferably comprise a first portion 105a, which comprises overpressure threshold values 106a for a first combination of an attachment 8 and a power setting of the fan 2, as well as a second portion 105b, which comprises overpressure threshold values 106b for a second combination of an attachment 8 and a power setting of the fan 2. A filling level 107a,b of the filter device 4 is assigned to each overpressure threshold value 106a,b. The selection of characteristic data 105, that is the selection of the portion 105a,b of the characteristic data 105, which is to be used for the evaluation takes place using the identification data 102 of the attachment 8. Depending on the type of attachment 8, different characteristic data 104 are thus employed for the determination 104 of the actual filling level of the filter device 4, The selected portion 105a,b of the characteristic data 105 is used in the determination 104 in that the currently determined pressure measurement value is compared to each of the overpressure threshold values 106a,b. If the pressure measurement value corresponds to the overpressure threshold value 106a,b, if required with a predetermined tolerance range, then the filling level 107a,b assigned to the respective overpressure threshold value 106a,b is selected as the actual filling level of the filter device 4. It is possible in this way to easily determine the actual filling level of the filter device 4 with only one pressure measurement value.

The invention is not limited to the depicted and described exemplary embodiments, but rather encompasses all embodiments of equivalent function in the sense of the invention. It is explicitly emphasized that the exemplary embodiments are not limited to all individual features in combination, but rather that each individual feature can be of importance for the invention independently from all other individual features. The invention has also so far not been restricted to the combination of features as described in claim 1, but rather can also be defined by any other desired combination of features out of all of the overall disclosed features. This means that in essence practically every individual feature can be omitted or replaced by at least one other feature described elsewhere in this application. In other words, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A suction device having at least one fan for generating a suction air stream in a suction channel, at least one filter device for receiving suction material, at least one pressure measuring system, and at least one control device, wherein the suction device is designed for coupling to a plurality of different attachments on the suction channel,
wherein the control device is configured and arranged for determining a filling level of the filter device using at least one pressure measurement value and characteristic data, as well as for selecting the characteristic data used for the determination depending on an attachment of the plurality of different attachments connected to the suction device.

2. The suction device according to claim 1, wherein the pressure measurement value represents an overpressure measurement value.

3. The suction device according to claim 1, wherein at least one comparison of the pressure measurement value to at least one portion of the characteristic data takes place, whereby an assignment to a filling level of the filter device takes place.

4. The suction device according to claim 1, wherein at least a portion of the characteristic data represents a plurality of overpressure threshold values, wherein each overpressure threshold value is assigned to at least one filling level of the filter device.

5. The suction device according to claim 1, wherein the characteristic data for each attachment out of the plurality of attachments comprises a different set of overpressure threshold values, wherein a specific set of overpressure threshold values is provided for every combination of power settings of the fan and every attachment out of the plurality of attachments.

6. The suction device according to claim 1, wherein the selection of the characteristic data used for the determination additionally takes place depending on a power setting of the fan selected by the user.

7. The suction device according to claim 1, wherein identification data concerning an attachment of the plurality of attachments are processed and/or generated by reading at least one identification means of the attachment and/or by transmission to an attachment interface and/or a data interface.

8. The suction device according to claim 1, wherein at least a portion of the characteristic data is made available in a memory of the control device, and/or at least a portion of the characteristic data can be retrieved and/or transmitted via a data interface.

9. The suction device according to claim 1, wherein at least a portion of the characteristic data is read by the control device from a memory every time the attachment is changed and/or every time the power setting is changed, and made available for a determination.

10. A method for determining a filling level of a filter device of a suction device with at least one suction channel, wherein the suction device is configured for coupling to a plurality of different attachments on the suction channel, the method comprises the following method steps:
Processing of identification data of an attachment of the plurality of attachments coupled to the suction device,
Determining of at least one pressure measurement value within the suction channel,
Determination of at least one filling level of the filter device using the processed identification data of the attachment, the pressure measurement value, as well as the characteristic data.

11. The method according to claim 10, wherein the determination of the filling level includes the selection of characteristic data,
wherein the selection of the characteristic data takes place using the identification data.

12. The method according to claim 10, wherein the determination of the filling level includes a comparison of the pressure measurement value to at least a portion of the selected characteristic data.

13. The method according to claim 10, wherein the characteristic data comprise at least a plurality of overpressure threshold values,
wherein each overpressure threshold value is assigned to a filling level of the filter device.

14. The method according to claim 10, wherein the processing of identification data includes the generation of identification data by the control device and/or the reception and/or transmission of identification data via an attachment interface and/or the reception and/or transmission of identification data concerning the coupled attachment via a data interface.

15. The method according to claim 10, wherein each time the suction device is turned on and/or each time the attachment is changed and/or each time the power setting of the fan is changed, the overpressure threshold values from the characteristic data) which correspond to the current combination of power setting and attachment are read by the control device from the memory means for the assignment of a fill status and are made available for a determination.

16. The suction device according to claim 2, wherein the overpressure measurement value is detectable in the air stream channel at a location behind the filter unit in the air flow direction.

17. The suction device according to claim 8, wherein the data interface is a network or a server or a mobile terminal device.

18. The method according to claim 13, wherein a different set of overpressure threshold values are made available for each attachment out of the plurality of attachments.

19. The method according to claim 13, wherein a specific set of overpressure threshold values is made available for each combination of power settings of the fan and each attachment out of the plurality of attachments.
